(19) United States
(12) Patent Application Publication
(10) Pub. No.: US 2021/0056571 A1
(43) Pub. Date: Feb. 25, 2021

(54) DETERMINING OF SUMMARY OF USER-GENERATED CONTENT AND RECOMMENDATION OF USER-GENERATED CONTENT

(71) Applicant: BEIJING SANKUAI ONLINE TECHNOLOGY CO., LTD., Beijing (CN)

(72) Inventors: Jing SU, Beijing (CN); Zhian YU, Beijing (CN); Qiang WANG, Beijing (CN); Shang WU, Beijing (CN); Peixu HOU, Beijing (CN); Chunyang LI, Beijing (CN); Yanhua WANG, Beijing (CN); Wenshi CHEN, Beijing (CN)

(21) Appl. No.: 17/093,969

(22) Filed: Nov. 10, 2020

Related U.S. Application Data
(63) Continuation of application No. PCT/CN2018/121321, filed on Dec. 14, 2018.

(30) Foreign Application Priority Data
May 11, 2018 (CN) 201810447372.7

(51) Int. Cl. G06Q 30/02; G06N 20/00; G06F 40/295; G06F 40/30; G06F 40/253

(52) U.S. Cl. CPC G06Q 30/0201; G06N 20/00; G06F 40/253; G06F 40/30; G06F 40/295

(57) ABSTRACT

A method for determining a summary of user-generated content. In an embodiment, the method includes: determining a plurality of sequentially arranged sentences included in user-generated content; then, determining a quality score of each sentence; and finally, determining a sentence group having the highest quality score as a summary of the user-generated content according to a constraint condition of a maximum summary character length and the quality score of each sentence, where sentences included in the sentence group are consecutive.

### CROSS-REFERENCE TO RELATED APPLICATIONS

This application claims the priority to Chinese Patent Application No. 201810447372.7, entitled “METHOD AND APPARATUS FOR DETERMINING SUMMARY OF GENERATED CONTENT, AND METHOD AND APPARATUS FOR RECOMMENDING GENERATED CONTENT” filed on May 11, 2018, which is incorporated herein by reference in its entirety.

### TECHNICAL FIELD

This application relates to a method and an apparatus for determining a summary of user-generated content and a method and an apparatus for recommending user-generated content in the field of computer technologies.

### BACKGROUND

A summary is a brief description of an article or a paragraph of text, and usually expresses the core meaning of the article or the text. A method for automatically generating a summary from an article may be regarded as an information compression process. Information loss is inevitable in a process of compressing an inputted article or inputted text into a brief summary.

### SUMMARY

This application provides a method and an apparatus for determining a summary of user-generated content, and a method and an apparatus for recommending user-generated content.

According to a first aspect, an embodiment of this application provides a method for determining a summary of user-generated content, including: determining a plurality of sequentially arranged sentences included in user-generated content; determining a quality score of each sentence; and determining a sentence group having the highest quality score according to a constraint condition of a maximum summary character length and the quality score of each sentence as a summary of the user-generated content, where sentences included in the sentence group are consecutive.

According to a second aspect, an embodiment of this application provides an apparatus for determining a summary of user-generated content, including: a sentence determining module, configured to determine a plurality of sequentially arranged sentences included in user-generated content; a sentence quality score determining module, configured to determine a quality score of each sentence; and a summary determining module, configured to determine a sentence group having the highest quality score according to a constraint condition of a maximum summary character length and the quality score of each sentence as a summary of the user-generated content, where sentences included in the sentence group are consecutive.

According to a third aspect, an embodiment of this application further discloses a method for recommending user-generated content, including: determining target businesses of a user; determining candidate user-generated content according to an evaluation score of user-generated content of the target businesses; determining target user-generated content matching the user in the candidate user-generated content; determining a summary of the target user-generated content by using the method for determining a summary of user-generated content according to an embodiment of this application; and recommending the summary of the target user-generated content to the user.

According to a fourth aspect, an embodiment of this application further discloses an apparatus for recommending user-generated content, including: a target-business determining module, configured to determine target businesses of a user; a candidate user-generated content determining module, configured to determine candidate user-generated content according to an evaluation score of user-generated content of the target businesses; a matched candidate user-generated content determining module, configured to determine target user-generated content matching the user in the candidate user-generated content; a generated content summary determining module, configured to determine a summary of the target user-generated content by using the method for determining a summary of user-generated content according to an embodiment of this application; and a recommendation module, configured to recommend the summary of the target user-generated content to the user.

According to a fifth aspect, an embodiment of this application further discloses an electronic device, including a memory, a processor, and a computer program that is stored in the memory and that is executable on the processor, the processor, when executing the computer program, implementing the method for determining a summary of user-generated content and the method for recommending user-generated content according to the embodiments of this application.

According to a sixth aspect, an embodiment of this application provides a computer-readable storage medium, storing a computer program, the program, when executed by a processor, implementing steps of the method for determining a summary of user-generated content and the method for recommending user-generated content disclosed in the embodiments of this application.

In the method for determining a summary of user-generated content disclosed in the embodiments of this application, a plurality of sequentially arranged sentences included in user-generated content are determined; then, a quality score of each sentence is determined; and finally, a sentence group having the highest quality score is determined according to a constraint condition of a maximum summary character length and the quality score of each sentence as a summary of the user-generated content, where sentences included in the sentence group are consecutive. This method can effectively and accurately extract a summary of user-generated content.

### BRIEF DESCRIPTION OF THE DRAWINGS

To describe the technical solutions in the embodiments of this application more clearly, the following briefly describes the accompanying drawings required for describing the embodiments. Apparently, the accompanying drawings in the following description show only some embodiments of this application, and a person of ordinary skill in the art may still derive other accompanying drawings from these accompanying drawings without creative efforts.

FIG. 1 is a flowchart of a method for determining a summary of user-generated content according to Embodiment 1 of this application.

FIG. 2 is a flowchart of a method for determining a summary of user-generated content according to Embodiment 2 of this application.

FIG. 3 is a flowchart of a method for recommending user-generated content according to Embodiment 3 of this application.

FIG. 4 is a flowchart of a method for recommending user-generated content according to Embodiment 4 of this application.

FIG. 5 is a schematic structural diagram 1 of an apparatus for determining a summary of user-generated content according to Embodiment 5 of this application.

FIG. 6 is a schematic structural diagram 1 of an apparatus for recommending user-generated content according to Embodiment 6 of this application.

FIG. 7 is a schematic structural diagram 2 of an apparatus for recommending user-generated content according to Embodiment 6 of this application.

FIG. 8 schematically shows a block diagram of a computing processing device for implementing a method according to the disclosure.

FIG. 9 schematically shows a storage unit for holding or carrying program codes for implementing a method according to the disclosure.

### DETAILED DESCRIPTION OF THE EMBODIMENTS

The following clearly and comprehensively describes the technical solutions in the embodiments of this application with reference to the accompanying drawings in the embodiments of this application. Apparently, the described embodiments are some of embodiments of this application rather than all of the embodiments. All other embodiments obtained by a person of ordinary skill in the art based on the embodiments of this application without creative efforts shall fall within the protection scope of this application.

In a processing of determining a summary, to keep important information as much as possible, a common method includes information extraction, article classification, and lexical analysis, and then the summary is generated according to information that is obtained. Compared with a conventional article, user created content (UGC) has characteristics of a shorter article length, less obvious paragraphs, irregular sentence structures, and relatively casual use of words. Consequently, a summary of the user-generated content cannot be accurately extracted by using a conventional method for extracting a summary of an article or text.

### Embodiment 1

This embodiment discloses a method for determining a summary of generated content. As shown in FIG. 1, the method includes step 110 to step 130.

Step 110. Determine a plurality of sequentially arranged sentences included in user-generated content.

In an embodiment, data processing is first performed on the user-generated content, to extract sentences in the user-generated content, and the extracted sentences are arranged according to a sequence in which the sentences appear in the user-generated content.

Because the user-generated content, such as a user comment, does not have a fixed format requirement, the content and the format are diversified. In an embodiment, a preset punctuation is used as a separation mark between sentences, to divide the user-generated content into a plurality of sentences. The preset punctuation includes, but is not limited to, any one or more of the following: a full stop, an exclamation mark, a question mark, a comma, a space, a semicolon, a slight-pause mark, an ellipsis, an emoticon, and a tilde. A standard punctuation includes at least a full stop, an exclamation mark, a question mark, a comma, a semicolon, a slight-pause mark, a colon, and an ellipsis. In an embodiment, sentence segmentation is first performed on the user-generated content by using the standard punctuation. If sentences obtained after the sentence segmentation are still extremely long, sentence segmentation is performed again by using another punctuation. The sentences are arranged according to a sequence of locations at which the sentences appear in the user-generated content, to obtain M sequentially arranged sentences included in the user-generated content. M is a natural number greater than or equal to 1.

Step 120. Determine a quality score of each sentence.

In an embodiment, the quality score of the sentence may be determined by using features included in the sentence in information dimensions such as text, opinion, and entity. The text may further include information in dimensions such as location, length, keyword emotional attribute, and description of a business feature by a keyword. Information in an opinion dimension may be information, such as an evaluation object or an evaluation word, included in an opinion. Information in an entity dimension may be information in a dimension such as appearance frequency of an entity word or type of an entity word.

The quality score of the sentence is used for indicating a contribution of the sentence to the core idea of the user-generated content or a performance capability of the sentence.

Step 130. Determine a sentence group having the highest quality score according to a constraint condition of a maximum summary character length and the quality score of each sentence as a summary of the user-generated content, where sentences included in the sentence group are consecutive.

After the plurality of sequentially arranged sentences included in the user-generated content are determined, a sentence group having the highest information content is selected as the summary of the user-generated content. In an embodiment, a plurality of sentence groups of which lengths of included characters satisfy a preset character length condition are found by using a sliding window. A score of a sentence group is then determined according to quality scores of all sentences in the sentence group. Finally, a sentence group having the highest quality score is selected as the summary of the user-generated content.

In the method for determining a summary of user-generated content disclosed in the embodiments of this application, one or more sequentially arranged sentences included in user-generated content are determined, and then a quality score of each sentence is determined. A sentence group having the highest quality score is determined according to a constraint condition of a maximum summary character length and the quality score of each sentence as a summary of the user-generated content, so that the summary of the user-generated content can be effectively and accurately extracted.

### Embodiment 2

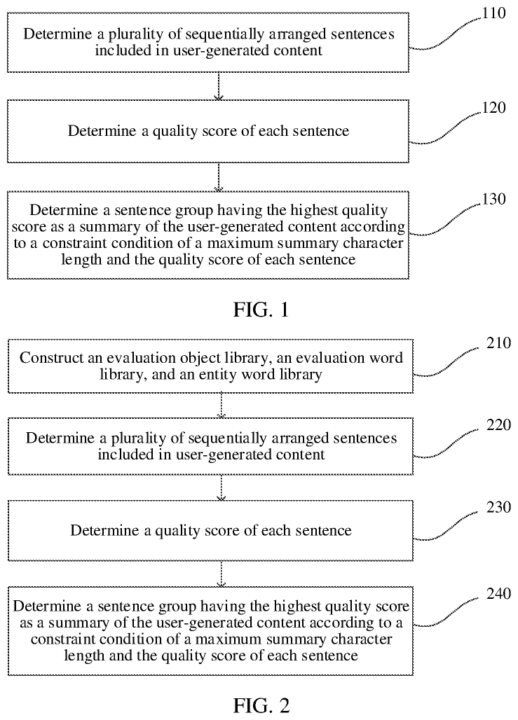

This embodiment discloses a method for determining a summary of generated content. As shown in FIG. 2, the method includes step 210 to step 240.

Step 210. Construct an evaluation object library, an evaluation word library, and an entity word library.

In an embodiment, to determine quality scores of sentences included in user-generated content, an evaluation object library, an evaluation word library, and an entity word library are first constructed, and then entities and evaluation objects included in the sentences, emotional keywords included in the sentences, and the like are determined based on the evaluation object library, the evaluation word library, and the entity word library.

In an embodiment, keywords, such as nouns and adjectives, are obtained according to hundreds of millions of UGC comments generated by massive users on a platform and tens of millions of query keywords every day by using a lexical analyzer, and part of speech categories (for example, a scenic spot, a cinema, a commercial area, and a shopping mall) of the keywords in the UGC comments and the query keywords are obtained with reference to the content of a preset POI knowledge base by using the N-Gram technology. Then, an evaluation object library having a relatively high coverage may be built through evaluation object mining, to provide support for the subsequent comment mining.

An entity is a subset in an evaluation object, and is a keyword selected from structured data of a business, a user, or the like, for example, a business name, a dishes category, or a dish name.

The keyword refers to a meaningful word that is obtained by performing word segmentation on UGC text. The evaluation word refers to a keyword such as an adjective, an adverb, or an idiom. In an embodiment, high-frequency evaluation words in the UGC comments are obtained, and distribution statuses of the evaluation words in 5-star comments and 1-star comments are obtained through statistics, to obtain polarities (positive, negative, and neutral) of the evaluation words. For example, a quantity of times that the evaluation word “good” appears in positive comments is far greater than a quantity of times that the evaluation word “good” appears in negative comments. Therefore, the polarity of the evaluation word “good” is positive. An evaluation word library may be built through evaluation word mining, to provide support for the subsequent comment mining Emotional information of a sentence may be determined by using an evaluation word.

Step 220. Determine a plurality of sequentially arranged sentences included in user-generated content.

In an embodiment, data processing is first performed on the user-generated content, to extract sentences in the user-generated content, and the extracted sentences are arranged according to a sequence in which the sentences appear in the user-generated content.

Because the user-generated content, such as a user comment, does not have a fixed format requirement, the content and the format are diversified. In an embodiment, a preset punctuation is used as a separation mark between sentences, to divide the user-generated content into a plurality of sentences. The preset punctuation includes, but is not limited to, any one or more of the following: a full stop, an exclamation mark, a question mark, a comma, a space, a semicolon, a slight-pause mark, a colon, an ellipsis, an emoticon, and a tilde. A standard punctuation includes at least a full stop, an exclamation mark, a question mark, a comma, a semicolon, a slight-pause mark, a colon, and an ellipsis. In an embodiment, sentence segmentation is first performed on the user-generated content by using the standard punctuation. If sentences obtained after the sentence segmentation are still extremely long, sentence segmentation is performed again by using another punctuation. The sentences are arranged according to a sequence of locations at which the sentences appear in the user-generated content, to obtain M sequentially arranged sentences included in the user-generated content. M is a natural number greater than or equal to 1.

In an embodiment, the determining one or more sequentially arranged sentences included in the user-generated content includes: performing sentence segmentation on the user-generated content based on a standard punctuation, to obtain first sentences included in the user-generated content; performing, based on an extended punctuation, sentence segmentation again on first sentences of which character lengths are greater than a preset sentence character length threshold in the first sentences, to obtain second sentences corresponding to the first sentences; arranging, according to a sequence of locations at which the sentences appear in the user-generated content, first sentences on which sentence segmentation is performed again according to the character length in the first sentences and the second sentences, to obtain M sequentially arranged sentences included in the user-generated content. M is a natural number greater than or equal to 1. The standard punctuation includes at least a full stop, a comma, a question mark, an exclamation mark, an ellipsis, a colon, a slight-pause mark, and a semicolon. The extended punctuation includes: a space, an emoticon, a tilde, and the like.

How to determine the plurality of sequentially arranged sentences included in the user-generated content is described by using an example in which a piece of user-generated content is “Authentic aged Sichuan pickles, fermented for three years, cooperate with uncontaminated sole fish from Vietnam \hat{ }_\hat{ } to provide a fresh and tender taste!”, and a preset sentence character length threshold is 10. First, sentence segmentation is performed on the user-generated content based on the standard punctuation, so that 3 first sentences in total, namely, “Authentic aged Sichuan pickles”, “fermented for three years”, and “cooperate with uncontaminated sole fish from Vietnam \hat{ }_\hat{ } to provide a fresh and tender taste”, may be obtained. A character length of a first sentence “cooperate with uncontaminated sole fish from Vietnam \hat{ }_\hat{ } to provide a fresh and tender taste” is 21, which is greater than the preset sentence character length threshold. Therefore, the sentence needs to be further divided based on the extended punctuation. Because the sentence includes an emoticon “\hat{ }_\hat{ }”, after the sentence is divided based on the extended punctuation, 2 second sentences are obtained, and are respectively “cooperate with uncontaminated sole fish from Vietnam” and “to provide a fresh and tender taste”. Finally, four sentences included in the user-generated content are determined as follows: the first sentences: “Authentic aged Sichuan pickles” and “fermented for three years”, and the second sentences: “cooperate with uncontaminated sole fish from Vietnam” and “to provide a fresh and tender taste”. Then, the fourth sentences are arranged in a sequence of locations at which the four sentences appear in the user-generated content, to obtain four sequentially arranged sentences included in the user-generated content, which are respectively: “Authentic aged Sichuan pickles”, “fermented for three years”, “cooperate with uncontaminated sole fish from Vietnam”, and “to provide a fresh and tender taste”.

Step 230. Determine a quality score of each sentence.

The quality score of the sentence is used for indicating a contribution of the sentence to the core idea of the user-generated content or a performance capability of the sentence. In an embodiment, the determining a quality score of each sentence includes: determining the quality score of the sentence according to information about a preset dimension of the sentence, where the preset dimension includes one or more of the following dimensions: text, entity, and opinion. The determining the quality score of the sentence according to information about a preset dimension of the sentence includes: performing weighted summation on an entity dimension score and an opinion dimension score of the sentence, to obtain an initial quality score; adjusting the initial quality score according to a text dimension score of the sentence; and determining the adjusted initial quality score as the quality score of the sentence.

In an embodiment, the performing weighted summation on an entity dimension score and an opinion dimension score of the sentence, to obtain an initial quality score, adjusting the initial quality score according to a text dimension score of the sentence, and determining the adjusted initial quality score as the quality score of the sentence includes determining the quality score of the sentence according to the following formula:

score(sentenceᵢ)=w×(α×score_sentenceᵢ(word∈entity)+β×score_sentenceᵢ(word∈evaluation object))

where score(sentenceᵢ) represents a quality score of a sentence i, score_sentenceᵢ(word∈entity) represents an entity dimension score of the sentence i, score_sentenceᵢ(word∈evaluation object) represents an opinion dimension score of the sentence i, and w′ represents a text dimension score of the sentence i.

An evaluation object is an evaluation object included in an opinion included in the sentence i, α represents a first weight regulatory factor corresponding to the entity dimension score, and β represents a second weight regulatory factor corresponding to the opinion dimension score. That is, first, an initial quality score is calculated by using the following formula:

α×score_sentenceᵢ(word∈entity)+β×score_sentenceᵢ(word∈evaluation object).

Then, the initial quality score is adjusted by using the text dimension score w′, to obtain the quality score of the sentence i.

In an embodiment, determining a text dimension score of a sentence according to a location of the sentence in the user-generated content, negative emotional information of the sentence, and business characteristic information includes: increasing a quality score of a sentence that is close to the header of the user-generated content, reducing a quality score of a sentence including negative emotional information, and increasing a quality score of a sentence including the business characteristic information. For example, for the first three sentences appearing in the user-generated content, quality scores of the first three sentences are increased, for example, by 10 points, to increase a probability that a sentence in the header of the user-generated content appears in the summary. For example, if a sentence includes a negative word in a preset evaluation word library, it is determined that the sentence includes a negative emotion. Therefore, a probability that the sentence appears in the summary is reduced by reducing a quality score of the sentence, for example, by 20 points. If a sentence includes an advertising word in the preset evaluation word library, a probability that the sentence appears in the summary is reduced by reducing a quality score of the sentence, for example, by 10 points. In another example, if a sentence includes a recommended dish that ranks the top three in a business or an evaluation object as a characteristic under the business category, a quality score of the sentence is increased, for example, by 10 points, thereby increasing a probability that the sentence appears in the summary.

The entity dimension score reflects a weight of an entity in the user-generated content. In an embodiment, an entity dimension score of a sentence is determined according to reverse text word frequencies of entity words included in the sentence. For example, the entity dimension score is a sum of reverse text word frequencies of entities included in the sentence, and the entity dimension score of the sentence is determined by using the following formula:

$${score\_sentence}_{i} ( word ∈ entity ) = {\sum }_{word ∈ entity}^{ } idf ( {word}_{j} )$$

In the formula, idf(wordⱼ) is a reverse text word frequency of an entity word wordⱼ included in the sentence. The reverse text word frequency of the entity may be determined by using the following formula:

$$i d f ( w o r {d}_{j} ) = log \frac{\vert shop\_num \vert}{1 + \vert \{ k \text{:} word ( j ) ∈ s h o {p}_{k} \} \vert}$$

In the formula, |shop_num| is a total quantity of businesses covered by the user-generated content, and {k:word(j)∈shopₖ} represents a total quantity of businesses for which a keyword word(j) appears.

In an embodiment, an opinion dimension score of a sentence is determined according to reverse text word frequencies of evaluation objects included in opinions included in the sentence.

The opinion dimension score reflects a weight of an evaluation object in the opinion in the user-generated content. In an embodiment, an opinion dimension score of a sentence is determined according to reverse text word frequencies of evaluation objects included in the sentence. For example, the opinion dimension score is a sum of reverse text word frequencies of evaluation objects included in opinions included in the sentence, and the opinion dimension score of the sentence is determined by using the following formula:

$${score\_sentence}_{i} ( word ∈ evaluation object ) = {\sum }_{word ∈ evaluation object}^{ } idf ( {word}_{i} )$$

In the formula, idf(wordₗ) is a reverse text word frequency of an evaluation object wordₗ included in the sentence. The reverse text word frequency of the evaluation object may be determined by using the following formula:

$$id f ( w o r {d}_{l} ) = log \frac{\vert shop\_num \vert}{1 + \vert \{ k \text{:} word ( l ) ∈ s h o {p}_{k} \} \vert}$$

In the formula, |shop_num| is a total quantity of businesses covered by the user-generated content, and {k:word(l)∈shopₖ} represents a total quantity of businesses for which a keyword word (l) appears.

In an embodiment, an opinion dimension score of a sentence is determined according to reverse text word frequencies of evaluation objects included in opinions included in the sentence. For example, the opinion dimension score of the sentence is determined by using the following formula:

$${score\_sentence}_{i} ( word ∈ evaluation object ) = {\sum }_{word ∈ evaluation object}^{ } idf ( {word}_{l} )$$

In the formula, idf(wordₗ) is a reverse text word frequency of an evaluation object wordₗ included in the sentence.

It can be seen from the foregoing formula, if a frequency of an entity or an evaluation object appearing in the user-generated content (such as a business comment) is low, a weight of a corresponding entity dimension score or opinion dimension score is high. Further, weighted summation is performed on the entity dimension score and the opinion dimension score, to obtain the quality score of the sentence. In an embodiment, weighted values of the entity dimension score and the opinion dimension score are set through experience and statistics.

Step 240. Determine a sentence group having the highest quality score according to a constraint condition of a maximum summary character length and the quality score of each sentence as a summary of the user-generated content, where sentences included in the sentence group are consecutive.

After the plurality of sequentially arranged sentences included in the user-generated content are determined, a sentence group having the highest information content is selected as the summary of the user-generated content.

In an embodiment, a sentence group between begin and end is determined by using the following formula as the summary of the user-generated content:

$$\{ \begin{matrix}argmax ( begin , end ) = w \times {\sum }_{i = begin}^{end} score ( sen t e n c {e}_{i} ) \\ s . t . 0 \leq begin < N , {\sum }_{begin}^{end} length ( sen t e n c {e}_{i} ) < max\_length\end{matrix}$$

where begin and end are sequence numbers of the sentences in the user-generated content, max_length is a preset maximum summary character length, length(sentenceᵢ) is a character length in a sentence i, w is a total score regulatory factor, and w is determined according to whether the sentenceᵢ, begin≤i≤end includes an entity and an opinion, and

$${\sum }_{begin}^{end} length ( sen t e n c {e}_{i} ) .$$

The determining a sentence group having the highest quality score as a summary of the user-generated content according to a constraint condition of a maximum summary character length and the quality score of each sentence includes: determining, by using a sliding window technology, one or more sentence groups satisfying the constraint condition of the maximum summary character length; determining, for each sentence group, a weighted sum of quality scores of sentences included in the sentence group as a quality score of the sentence group; and determining the sentence group having the highest quality score as the summary of the user-generated content. In an embodiment, weights of the quality scores of in the quality score of the sentence group are determined by using any one or more of the following factors: whether each sentence in the sentence group includes an entity and an opinion; a character length of the sentence group; and whether the sentence group includes the first sentence or the last sentence of the user-generated content.

In an embodiment, assuming that the preset maximum summary character length is 35, a summary determining method is described by using an example in which a piece of user-generated content includes nine sequentially arranged sentences, and a quality score and a character length of each sentence are shown in the following table. The numbers 1 to 9 of the sentences are sequence numbers of the sentences, and weights of quality scores of the sentences are the same, for example, being 1.

| | Sentence | Sentence | Sentence | Sentence | Sentence | Sentence | Sentence | Sentence | Sentence |
|---|---|---|---|---|---|---|---|---|---|
| | 1 | 2 | 3 | 4 | 5 | 6 | 7 | 8 | 9 |
| Character | 10 | 9 | 6 | 8 | 16 | 7 | 8 | 9 | 10 |
| length | | | | | | | | | |
| Quality | 0.5 | 0.2 | 1 | 2 | −10 | 2 | 3 | 3 | 2 |
| score | | | | | | | | | |

In an embodiment, first, starting with the sentence 1, sentence groups of which character lengths do not exceed 35 are found by adjusting a length of a window, for example, {sentence 1}, {sentence 1, sentence 2}, {sentence 1, sentence 2, sentence 3}, and {sentence 1, sentence 2, sentence 3, sentence 4}. Then, a quality score of each sentence group is determined, and a sentence group having the highest quality score is kept. For example, a sentence group formed by {sentence 1, sentence 2, sentence 3, sentence 4} is used as a candidate summary, and a quality score of the candidate summary is 3.7 points.

Next, the window is slid, starting from the sentence 2, and sentence groups of which character lengths do not exceed 35 are found by adjusting the length of the window, for example, {sentence 2}, {sentence 2, sentence 3}, and {sentence 2, sentence 3, sentence 4}. Then, a quality score of each sentence group is determined, and a sentence group having the highest quality score, such as a sentence group formed by {sentence 2, sentence 3, sentence 4}, is kept, and a quality score is 3.2 points.

The quality score of the candidate summary formed by {sentence 1, sentence 2, sentence 3, sentence 4} is greater than the quality score (3.2 points) of the sentence group formed by sentence 2, sentence 3, sentence 41. Therefore, the candidate summary formed by the sentence group sentence 1, sentence 2, sentence 3, sentence 41 is temporarily kept.

The rest is deduced by analogy. By using the sliding window technology, a plurality of sentence groups that are started from each sentence and of which character lengths do not exceed 35 are respectively determined, a quality score of each sentence group is determined, to update the temporarily kept candidate summary by using a sentence group with a higher quality score until the sentence group having the highest score is finally found, and the sentence group having the highest score is used as the summary of the user-generated content. Using the sentences in the foregoing table as an example, a sentence group {sentence 6, sentence 7, sentence 8, sentence 9} having a quality score of 10 pints is finally determined as the summary of the user-generated content.

In an embodiment, the determining a sentence group having the highest quality score as a summary of the user-generated content according to a constraint condition of a maximum summary character length and the quality score of each sentence includes: determining, by using a sliding window technology, one or more sentence groups satisfying the constraint condition of the maximum summary character length; determining, for each sentence group, a weighted sum of quality scores of sentences included in the sentence group as a quality score of the sentence group; and determining the sentence group having the highest quality score as the summary of the user-generated content.

When the quality score of the sentence group is determined, the quality scores of the sentences in the sentence group may have the same weight or different weights.

In an embodiment, assuming that the quality scores of the sentences in the sentence group have the same weight, a ratio of the weight to a character length of the sentence group and a ratio of the weight to the preset maximum summary character length are T, where T is a number greater than 1, for example, T=1.5. In this way, it can be avoided that a character length of the determined summary is extremely short. In an embodiment, assuming that the quality scores of the sentences in the sentence group have different weights, if an entity dimension score of a sentence is 0, for example, the sentence does not include an entity, a weight of a quality score of the sentence is reduced. If an opinion dimension score of a sentence is 0, for example, the sentence does not include an evaluation object, a weight of a quality score of the sentence is reduced. If a sentence is the first sentence or the last sentence of the user-generated content, a weight of a quality score of the sentence is increased. A weight of a quality score of a sentence is determined according to whether the sentence is the first sentence or the last sentence of the user-generated content, so that the integrity of sentences in the determined summary may be improved.

In the method for determining a summary of user-generated content disclosed in this embodiment of this application, a plurality of sequentially arranged sentences included in user-generated content are determined, then a quality score of each sentence is determined, and finally, a sentence group having the highest quality score is determined according to a constraint condition of a maximum summary character length and the quality score of each sentence as a summary of the user-generated content, so that the summary of the user-generated content can be effectively and accurately extracted. In this embodiment of this application, a quality score of a sentence is obtained by performing weighted calculation in three dimensions: text, entity, and opinion of the user-generated content. By using such a method, a sentence group having the highest information value density in the user-generated content can be found. In addition, the method for determining a summary of user-generated content disclosed in this embodiment of this application supports extraction of a summary of user-generated content that has improper use of punctuations and that even has ungrammatical sentences, has stronger robustness, and may adaptively extract a summary of the user-generated content with a business characteristic according to different requirements on the length of the summary.

### Embodiment 3

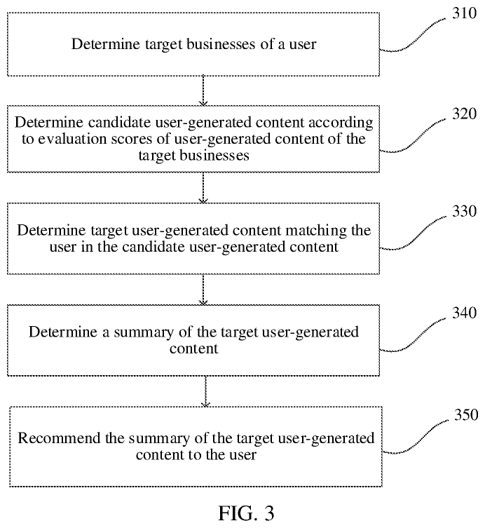

This embodiment discloses a method for recommending generated content. As shown in FIG. 3, the method includes step 310 to step 350.

Step 310. Determine target businesses of a user.

In an embodiment, first, a business on which the user has generated a preset historical behavior is determined as a first target business according to historical behavioral data of the user; then, a business similar to the first target business is determined as a second target business; and finally, the first target business and the second target business are used as the target businesses of the user.

Step 320. Determine candidate user-generated content according to evaluation scores of user-generated content of the target businesses.

The user-generated content of the target businesses is obtained, and an evaluation score of each piece of user-generated content is further determined. In an embodiment, the evaluation scores of the user-generated content may be determined according to text information, entity information, opinion information, and the like of the user-generated content. In an embodiment, a higher evaluation score indicates higher quality of the user-generated content, that is, information shown by the user-generated content to the user is more valuable. Then, pieces of user-generated content of the target businesses are sorted in descending order of evaluation scores of the pieces of user-generated content. After that, for each target business, a preset quantity of pieces of user-generated content having the highest evaluation scores are selected as candidate user-generated content.

Step 330. Determine target user-generated content matching the user in the candidate user-generated content.

In an embodiment, a feature vector of the user and feature vectors of the candidate user-generated content may be respectively extracted, and then, target user-generated content matching the user in the candidate user-generated content is determined by calculating similarities between the feature vector of the user and the feature vectors of the candidate user-generated content. In an embodiment, a matching degree between the user and a piece of candidate user-generated content may be determined by calculating a similarity distance between the feature vector of the user and a feature vector of the piece of candidate user-generated content. Alternatively, a matching degree between the user and a piece of candidate user-generated content is calculated by using a pre-trained machine-learning sorting model according to the inputted feature vector of the user and a feature vector of the piece of candidate user-generated content.

Then, one piece of or a preset quantity of pieces of candidate user-generated content having the highest matching degrees with the user are selected as the target user-generated content.

Step 340. Determine a summary of the target user-generated content.

The summary of the target user-generated content is determined by using the method for determining a summary of user-generated content according to Embodiment 1 and Embodiment 2.

Step 350. Recommend the summary of the target user-generated content to the user.

After the target user-generated content matching the user is determined, the summary of the target user-generated content is recommended to the user.

In the method for recommending user-generated content disclosed in this embodiment of this application, target businesses of a user is determined; candidate user-generated content is determined according to evaluation scores of user-generated content of the target businesses; target user-generated content matching the user in the candidate user-generated content is determined; and finally, a summary of the target user-generated content is recommended to the user, where the summary of the target user-generated content is determined by using the method for determining a summary of user-generated content according to Embodiment 1 or Embodiment 2. In this way, compared with the solution of recommending user-generated content for a user according to a popularity of user-generated content, user-generated content that is more accurate is recommended according to a user requirement. In the method for recommending user-generated content disclosed in this embodiment of this application, the user-generated content matching the user is recommended to the user, thereby implementing targeted information recommendation, and effectively improving the accuracy of recommendation of the user-generated content. Moreover, during recommendation of generated content for the user, only a summary of the generated content is shown, so that key information of the recommendation is shown to the user in a concise and clear manner, which helps the user accurately and quickly make a decision, and further improves the user experience.

### Embodiment 4

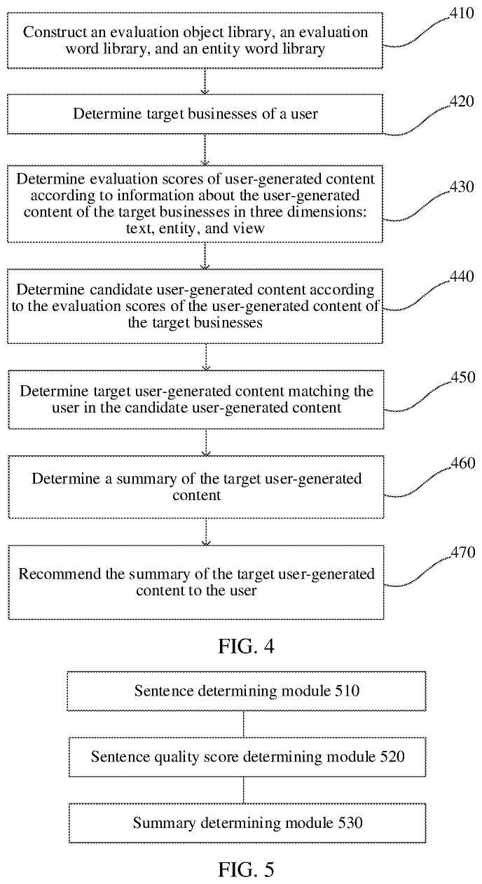

This embodiment discloses a method for recommending user-generated content. As shown in FIG. 4, the method includes step 410 to step 470.

Step 410. Construct an evaluation object library, an evaluation word library, and an entity word library.

For a specific implementation of constructing the evaluation object library, the evaluation word library, and the entity word library, refer to Embodiment 2. Details are not described again in this embodiment.

Step 420. Determine target businesses of a user.

In an embodiment, the determining target businesses of a user includes: determining a business on which the user has generated a preset behavior as a first target business; determining a second target business similar to the first target business based on a similarity between business vectors; and using the first target business and the second target business as the target businesses of the user.

In an embodiment, first, a business on which the user has generated a preset historical behavior is determined as a first target business according to historical behavioral data of the user. The business on which the user has generated a preset behavior includes, but is not limited to, a business that has been clicked by the user, a business that has been browsed by the user, a business that has been added to favorites by the user, and a business at which the user has purchased a merchandise.

Then, a business similar to the first target business is further determined as a second target business.

In an embodiment, before the determining a second target business similar to the first target business based on a similarity between business vectors, the method further includes: training a business vector model by using a business sequence clicked by the user as an input of a word vector model; and determining a business vector of the first target business by using the business vector model.

In an embodiment, a behavior performed by the user on a business is converted into a time sequence event, and then a business vector model is trained by using the time sequence event as an input and by using a deep learning algorithm. That is, a business feature is mapped from a high-dimensional discrete space to a low-dimensional consecutive space. For example, when the user clicks a business 1, a business 2, and a business 3 one after the other, a business identifier sequence of the business 1, the business 2, and the business 3 may be used as an input sample for training the business vector model. Then, a business vector corresponding to a business identifier may be obtained by using the pre-trained business vector model.

After business vectors of all businesses are determined, a second target business similar to the first target business may be determined by calculating a similarity between each business vector and the business vector of the first target business.

Finally, the first target business and the second target business are used as the target businesses of the user. For example, if it is determined, according to a historical behavior of the user, that the user has clicked a business 1, the business 1 is used as the first target business of the user. Then, a business 2 similar to the business 1 is determined by calculating a similarity between business vectors, so that the business 2 is used as the second target business of the user. Finally, the business 1 and the business 2 are used as the target businesses of the user.

Step 430. Determine evaluation scores of user-generated content according to information about the user-generated content of the target businesses in three dimensions: text, entity, and opinion.

Before candidate user-generated content is determined according to the evaluation scores of the user-generated content of the target businesses, the method further includes: determining the evaluation scores of the user-generated content according to information about the user-generated content of the target businesses in three dimensions: text, entity, and opinion. For example, the determining the evaluation scores of the user-generated content according to information about the user-generated content of the target businesses in three dimensions: text, entity, and opinion may include: according to performing weighted summation on text scores, entity scores, and opinion scores of the user-generated content, obtaining the evaluation scores of the user-generated content.

In an embodiment, first, for user-generated content in a platform such as user comments, user-generated content within a latest preset time (such as within a half year) is selected. Then, the evaluation scores of the user-generated content are determined according to the information about the user-generated content in three dimensions: text, entity, and opinion. Because a high-quality business or a high-star user also has low-quality user-generated content, user-generated content is scored according to only the content quality of the user-generated content without considering features of the business and the user, that is, an evaluation score of the user-generated content is obtained through calculation in three dimensions: text, entity, and opinion.

In an embodiment, the text score is in direct proportion to a quantity of different words included in the user-generated content. That is, more different words included in the user-generated content indicate a higher text score. The text score is determined according to a quantity of different words included in the user-generated content, so that user-generated content in which a user repeatedly uses the same punctuation or word as the complement of the word count may be effectively filtered out.

In an embodiment, the entity score may be represented by using reverse text word frequencies of entities included in the user-generated content, and the opinion score may be represented by using reverse text word frequencies of evaluation objects included in opinions included in the user-generated content.

Before the entity score and the opinion score are determined, the user-generated content is first divided into a plurality of sentences. For a specific method for dividing the user-generated content into a plurality of sentences, reference may be made to the method for determining the sentences in the user-generated content in Embodiment 2, and details are not described again in this embodiment.

Then, entities and opinions included in each sentence obtained through division of the user-generated content are determined by using a preset entity word library.

The entity refers to a comment object included in the user-generated content, for example, a business name, an address, a category, a shopping mall, a starred hotel, a residential community, a cinema, an administrative region, or a city. The entity is important information in the user-generated content. For example, information about content, such as a recommended dish, an address, and a category, that is mentioned in a piece of user-generated content, may be used as an important feature of the piece of user-generated content. In an online-to-offline (O2O) scenario, information extraction is different from conventional recognition of a personal name, a place name, and a company name, and weight information of different keywords in different dimensions needs to be mined. For example, in business comments under a food category, a comment count of “Dream of Dragon” is relatively few, so that a reverse text word frequency of “Dream of Dragon” is higher than that of “Cantonese cuisine”. In an embodiment, an entity score of a piece of user-generated content may be determined by using the following formula:

$$score\_ugc = {\sum }_{word ∈ entity} idf ( {word}_{p} )$$

In the formula, idf(wordₚ) is a reverse text word frequency of an entity word wordₚ included in the piece of user-generated content. The reverse text word frequency of the entity word may be determined by using the following formula:

$$i d f ( w o r {d}_{p} ) = log \frac{\vert shop\_num \vert}{1 + \vert \{ k \text{:} word ( p ) ∈ s h o {p}_{k} \} \vert}$$

In the formula, |shop_num| is a total quantity of businesses covered by the user-generated content, and {k:word(p)∈shopₖ} represents a total quantity of businesses for which a keyword wordₚ appears.

The opinion indicates subjective and objective judgment information of a specific evaluation object, and in this application, an opinion is mainly extracted from a sentence. For example, for a sentence “The espresso coffee bean is a classic of The Piye's” in a piece of user-generated content, a specific method for extracting an opinion from the sentence is as follows: determining, according to a pre-constructed evaluation object library, that an evaluation object included in the sentence is a coffee bean; determining, according to a pre-constructed evaluation word library, that evaluation words included in the sentence are: “espresso” and “classic”; and combining the evaluation object with the evaluation words included in the sentence, to obtain opinions included in the sentence, that is, “coffee bean-classic” and “coffee bean-espresso”. Then, a confidence of each opinion is obtained according to a proportion of the foregoing two opinions appearing in the user-generated content. In an embodiment, a higher frequency of appearance of an opinion indicates a higher confidence. Finally, all opinions in the piece of user-generated content and confidences of the opinions are obtained.

For each opinion obtained in a piece of user-generated content, a vector representation of the opinion is obtained by performing summation on evaluation objects and word vectors of evaluation words included in the opinion. After the opinions are represented by using vectors, a distance between vectors may be calculated by using the cosine law, to determine a similarity relationship between the opinions. In an embodiment, the following opinion data structure table may be obtained by analyzing the sentence:

| Field name | Field description | Example |
|---|---|---|
| Opinion | Opinion | Coffee bean-classic |
| SemanticVector | Word vector | [0, 1, 0.32, 0.16, 0.07 . . . ] |
| Aspect | Evaluation object | Coffee bean |
| Evaluate | Evaluation word | Classic |
| Confidence | Confidence | 0.87 |
| Updatetime | Update time | Mar. 12, 2018, 9:00:00 AM |

In an embodiment, training samples are obtained by performing word segmentation on all user-generated content generated by users, and a word vector of each keyword in the training samples is obtained by using a word vector technology known to a person skilled in the art. In an embodiment, the keyword includes an entity word, an evaluation word, and various meaningful general words. The word vector is a vector representation of a keyword. In an embodiment, a word vector of a keyword is a one-dimensional vector of a floating-point type with a fixed length. For example, a word vector model is trained by using a negative sampling method of a skip-gram model. After the word vector technology is used, all keywords may be represented by using a vector with a fixed length, and an original sparse and huge dimension is compressed into a smaller dimension space. For example, two words, “Pisa” and “pizza” has no similarity in text. However, after the two words are represented by using word vectors, a semantic distance between the two words is relatively short.

Finally, weighted summation is performed on entity scores of entities included in a piece of user-generated content, opinion scores of opinions included in the piece of user-generated content, and a text score of the piece of user-generated content, and an obtained total score is used as an evaluation score of the piece of user-generated content. In an embodiment, weighting is performed on the entity scores, the opinion scores, and the text score, and a weighted value of each type of score is set according to a specific requirement. Generally, a weighted value of an opinion score is the highest, and a weighted value of a text score is the lowest.

Step 440. Determine candidate user-generated content according to the evaluation scores of the user-generated content of the target businesses.

As described above, assuming that the business 1 and the business 2 are used as the target businesses of the user, a plurality of pieces of user-generated content with evaluation scores satisfying a preset condition are respectively selected as candidate user-generated content of the user from user-generated content of the business 1 and the business 2 according to evaluation scores of the user-generated content. For example, the user-generated content of the business 1 and the business 2 is sorted in descending order of the evaluation scores, and then, M pieces of user-generated content with the highest evaluation scores of the business 1 and M pieces of user-generated content with the highest evaluation scores of the business 2 are selected as the candidate user-generated content.

Step 450. Determine target user-generated content matching the user in the candidate user-generated content.

In an embodiment, the determining target user-generated content matching the user in the candidate user-generated content includes: determining a matching degree between each piece of candidate user-generated content and the user respectively according to a sorting feature of each piece of candidate user-generated content and a user feature of the user; and determining candidate user-generated content having a matching degree satisfying a preset condition as the target user-generated content matching the user.

In an embodiment, a matching degree recognition model may be first trained based on the sorting feature of the user-generated content and the user feature of the user through machine learning. For example, a sorting feature of user-generated content and a user feature of a user publishing the generated content are combined as a positive sample, and a sorting feature of user-generated content and a user feature of a user that dislikes the generated content are combined as a negative sample, to train the matching degree recognition model. Then, the matching degree recognition model recognizes, based on a sorting feature of user-generated content and a user feature of a user that are inputted, a matching degree between the user-generated content and the user. the sorting feature includes any one or more of a like count, a comment count, a share count, a text quality score, an image quality score, an entity word, a level of a publisher of user-generated content, and a relationship between a publisher and the user; the user feature includes any one or more of a historical user behavior feature, a commercial area preference feature, a category preference feature, and a similar user feature; and the historical user behavior feature includes a feature of any one or more of a searching behavior, a browsing behavior, a purchasing behavior, and an behavior of entering a store.

In an embodiment, a preset quantity of pieces of candidate user-generated content having the highest matching degree scores may be determined as the target user-generated content matching the user. Alternatively, one piece of candidate user-generated content having the highest matching degree score with the user is determined as the target user-generated content matching the user in the candidate user-generated content corresponding to each business. During the matching degree recognition, features, such as a user preference and a user social relationship, are combined. Therefore, the determined target user-generated content is user-generated content that is preferred by the user.

Step 460. Determine a summary of the target user-generated content.

In an embodiment, the summary of the target user-generated content is determined by using the method for determining a summary of user-generated content according to Embodiment 1 and Embodiment 2, and a specific summary determining method is not described again in this embodiment.

Step 470. Recommend the summary of the target user-generated content to the user.

After the target user-generated content matching the user is determined, the summary of the target user-generated content is recommended to the user.

In the method for recommending user-generated content disclosed in this embodiment of this application, target businesses of a user is determined; then evaluation scores of user-generated content of the target businesses are determined, and candidate user-generated content is determined according to the evaluation scores of the user-generated content of the target businesses; target user-generated content matching the user in the candidate user-generated content and a summary thereof are determined; and finally, the summary of the target user-generated content is recommended to the user. In this way, compared with the solution of recommending user-generated content for a user according to a popularity of user-generated content, user-generated content that is more accurate can be recommended according to a user requirement. In the method for recommending user-generated content disclosed in this embodiment of this application, the user-generated content matching the user is recommended to the user, thereby implementing targeted information recommendation, and effectively improving the accuracy of recommendation of the user-generated content. Moreover, during recommendation of user-generated content for the user, only a summary of the user-generated content is shown, so that key information of the recommendation is shown to the user in a concise and clear manner, which helps the user accurately and quickly make a decision, and further improves the user experience.

An evaluation score of user-generated content is determined by using text information, entity information, and opinion information of the user-generated content, which can improve the accuracy of quality evaluation of the user-generated content, and further improve the accuracy of recommendation of the user-generated content.

### Embodiment 5

This embodiment discloses an apparatus for determining a summary of user-generated content. As shown in FIG. 5, the apparatus includes:

a sentence determining module 510, configured to determine one or more sequentially arranged sentences included in user-generated content;

a sentence quality score determining module 520, configured to determine a quality score of each sentence; and

a summary determining module 530, configured to determine a sentence group having the highest quality score as a summary of the user-generated content according to a constraint condition of a maximum summary character length and the quality score of each sentence, where sentences included in the sentence group are consecutive.

Optionally, the sentence quality score determining module 520 is further configured to:

determine the quality score of the sentence according to information about a preset dimension of the sentence, where the preset dimension includes one or more of the following dimensions: text, entity, and opinion.

Optionally, the determining the quality score of the sentence according to information about a preset dimension of the sentence includes: performing weighted summation on an entity dimension score and an opinion dimension score of each sentence, to obtain an initial quality score, and adjusting the initial quality score according to a text dimension score of the sentence; and determining the adjusted initial quality score as the quality score of the sentence. In an embodiment of this application, the performing weighted summation on an entity dimension score and an opinion dimension score of each sentence, to obtain an initial quality score, adjusting the initial quality score according to a text dimension score of the sentence, and determining the adjusted initial quality score as the quality score of the sentence further includes:

determining the quality score of each sentence according to the following formula:

score(sentenceᵢ)=w′×(α×score_sentenceᵢ(word∈entity)+β×score_sentenceᵢ(word∈evaluation object))

where score(sentenceᵢ) represents a quality score of a sentence i, score_sentenceᵢ(word∈entity) represents an entity dimension score of the sentence i, score_sentenceᵢ(word∈evaluation object) represents an opinion dimension score of the sentence i, and w′ represents a text dimension score of the sentence i. An evaluation object is an evaluation object included in an opinion included in the sentence, α represents a first weight regulatory factor corresponding to the entity dimension score, and β represents a second weight regulatory factor corresponding to the opinion dimension score.

Optionally, the summary determining module 530 is further configured to:

determining, by using a sliding window technology, one or more sentence groups satisfying the constraint condition of the maximum summary character length;

determining, for each sentence group, a weighted sum of quality scores of sentences included in the sentence group as a quality score of the sentence group; and

determining the sentence group having the highest quality score as the summary of the user-generated content.

Optionally, weights of the quality scores in the quality score of the sentence group are determined by using any one or more of the following factors: whether each sentence in the sentence group includes an entity and an opinion; a character length of the sentence group; and whether the sentence group includes the first sentence or the last sentence of the user-generated content.

This embodiment is an apparatus embodiment corresponding to Embodiment 1 and Embodiment 2. For a specific implementation of modules in this embodiment, reference may be made to the description of related steps in Embodiment 1 and Embodiment 2, and details are not described herein again.

A plurality of sequentially arranged sentences included in user-generated content are determined, and a quality score of each sentence is determined; and then, a sentence group having the highest quality score is determined as a summary of the user-generated content according to a constraint condition of a maximum summary character length and the quality score of each sentence, where sentences included in the sentence group are consecutive. The apparatus for determining a summary of user-generated content in this embodiment of the disclosure resolves the problem that a summary of generated content cannot be accurately extracted. Through test of a large quantity of user-generated content, in the apparatus for determining a summary of user-generated content disclosed in this application, the summary of the user-generated content may be effectively and accurately determined. By using a method of obtaining quality score of a sentence by performing weighted calculation in three dimensions: text, entity, and opinion of the user-generated content, a sentence group having the highest information value density in the user-generated content can be found in this embodiment of the disclosure. In addition, the method for determining a summary of user-generated content disclosed in this embodiment of this application supports extraction of a summary of user-generated content that has improper use of punctuations and that even has ungrammatical sentences, has stronger robustness, and may adaptively extract a summary of the user-generated content with a business characteristic according to different requirements on the length of the summary.

### Embodiment 6

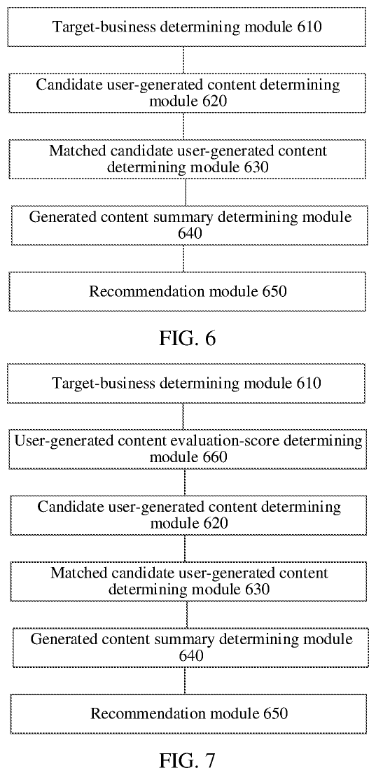

This embodiment discloses an apparatus for recommending user-generated content. As shown in FIG. 6, the apparatus includes:

a target-business determining module 610, configured to determine target businesses of a user;

a candidate user-generated content determining module 620, configured to determine candidate user-generated content according to evaluation scores of user-generated content of the target businesses;

a matched candidate user-generated content determining module 630, configured to determine target user-generated content matching the user in the candidate user-generated content;

a generated content summary determining module 640, configured to determine a summary of the target user-generated content by using the method for determining a summary of user-generated content according to an embodiment of this application; and

a recommendation module 650, configured to recommend the summary of the target user-generated content to the user, where the summary of the target user-generated content is determined by using the method for determining a summary of user-generated content according to Embodiment 1 and Embodiment 2

Optionally, as shown in FIG. 7, the apparatus further includes:

a user-generated content evaluation-score determining module 660, configured to determine the evaluation scores of the user-generated content according to information about the user-generated content in three dimensions: text, entity, and opinion.

Optionally, the target-business determining module 610 is further configured to:

determine a business on which the user has generated a preset behavior as a first target business; determine a second target business similar to the first target business based on a similarity between business vectors; and use the first target business and the second target business as the target businesses of the user.

Optionally, the target-business determining module 610 is further configured to:

train a business vector model by using a business sequence clicked by the user as an input of a word vector model; and determine a business vector of the first target business by using the business vector model.

Optionally, the matched candidate user-generated content determining module 630 is further configured to:

determine a matching degree between each piece of candidate user-generated content and the user respectively according to a sorting feature of each piece of candidate user-generated content and a user feature of the user; and determine candidate user-generated content having a matching degree satisfying a preset condition as the target user-generated content matching the user.

the sorting feature includes any one or more of a like count, a comment count, a share count, a text quality score, an image quality score, an entity word, a level of a publisher of user-generated content, and a relationship between a publisher and the user; the user feature includes any one or more of a historical user behavior feature, a commercial area preference feature, a category preference feature, and a similar user feature; and the historical user behavior feature includes a feature of any one or more of a searching behavior, a browsing behavior, a purchasing behavior, and an behavior of entering a store.

This embodiment is an apparatus embodiment corresponding to Embodiment 3 and Embodiment 4. For a specific implementation of modules in this embodiment, reference may be made to the description of related steps in Embodiment 3 and Embodiment 4, and details are not described herein again.

Target businesses of a user is determined; then evaluation scores of user-generated content of the target businesses are determined, and candidate user-generated content is determined according to the evaluation scores of the user-generated content of the target businesses; target user-generated content matching the user in the candidate user-generated content and a summary thereof are determined; and finally, the summary of the target user-generated content is recommended to the user. The apparatus for recommending user-generated content in this embodiment of the disclosure resolves the problem that a user requirement cannot be satisfied because when user-generated content is recommended for a user according to a popularity of user-generated content, the recommended user-generated content is inaccurate. The user-generated content matching the user is recommended to the user, thereby implementing targeted information recommendation, so that the apparatus for recommending user-generated content in this embodiment of the disclosure effectively improves the accuracy of recommendation of the user-generated content. Moreover, during recommendation of generated content for the user, only a summary of the generated content is shown, so that key information of the recommendation is shown to the user in a concise and clear manner, which helps the user accurately and quickly make a decision, and further improves the user experience.

An evaluation score of user-generated content is determined by using text information, entity information, and opinion information of the user-generated content, which can improve the accuracy of quality evaluation of the user-generated content, and further improve the accuracy of recommendation of the user-generated content.

Correspondingly, this application further discloses an electronic device, including a memory, a processor, and a computer program that is stored in the memory and that is executable on the processor, the processor, when executing the computer program, implementing the method for determining a summary of generated content in this application according to Embodiment 1 and Embodiment 2 or the method for recommending generated content according to Embodiment 3 and Embodiment 4 in this application. The electronic device may be a PC, a mobile terminal, a personal digital assistant, a tablet computer, or the like.

This application further discloses a nonvolatile computer-readable storage medium, storing a computer program, the program, when executed by a processor, implementing the method for determining a summary of generated content according to Embodiment 1 and Embodiment 2 in this application or the method for recommending user-generated content according to Embodiment 3 and Embodiment 4 in this application.

The embodiments in this specification are all described in a progressive manner. Description of each of the embodiments focuses on differences from other embodiments, and reference may be made to each other for the same or similar parts among respective embodiments. The apparatus embodiments are substantially similar to the method embodiments and therefore are only briefly described, and reference may be made to the method embodiments for the associated part.

The method and apparatus for determining a summary of user-generated content in this application and the method and apparatus for recommending user-generated content are described in detail above. The principle and implementations of this application are described herein by using specific examples. The descriptions of the foregoing embodiments are merely used for helping understand the method and core ideas of this application. In addition, a person of ordinary skill in the art can make variations to this application in terms of the specific implementations and application scopes according to the ideas of this application. Therefore, the content of this specification shall not be construed as a limit on this application.

Based on the foregoing descriptions of the embodiments, a person skilled in the art may clearly understand that each implementation may be implemented by software in addition to a necessary general hardware platform or by hardware. Based on such an understanding, the foregoing technical solutions essentially or the part contributing to the prior art may be implemented in a form of a software product. The computer software product may be stored in a computer-readable storage medium, such as a ROM/RAM, a hard disk, or an optical disc, and includes several instructions for instructing a computer device (which may be a personal computer, a server, a network device, or the like) to perform the methods described in the embodiments or some parts of the embodiments.

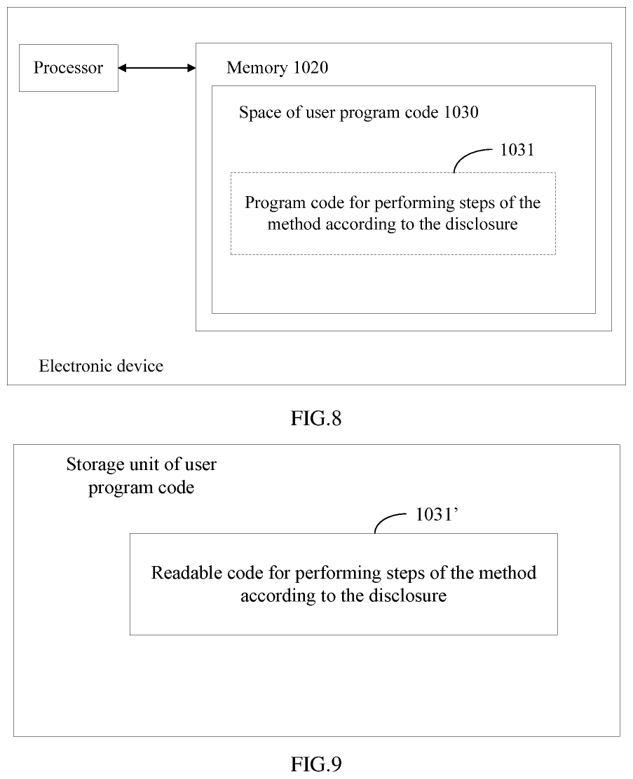

For example, FIG. 8 shows an electronic device in which the method according to the disclosure may be implemented. The electronic device conventionally includes a processor 1010 and a computer program product or computer-readable medium in the form of a memory 1020. The memory 1020 may be an electronic memory such as a flash memory, an EEPROM (Electrically Erasable Programmable Read Only Memory), an EPROM, a hard disk, or a ROM. The memory 1020 has a storage space 1030 for program codes 1031 for performing any of the method steps in the above methods. For example, the storage space 1030 for program codes may include respective program codes 1031 for implementing the various steps in the above methods, respectively. The program codes may be read from or written to one or more computer program products. These computer program products include a program code carrier such as a hard disk, a compact disk (CD), a memory card or a floppy disk. Such a computer program product is typically a portable or fixed storage unit as described with reference to FIG. 9. The storage unit may have storage segments, storage space, etc., arranged similarly to the memory 1020 in the computing processing device of FIG. 8. The program codes may be compressed, for example, in a suitable form. Typically, the storage unit includes computer-readable codes 1031′, i.e., codes readable by a processor, such as 1010, for example, which, when executed by an electronic device, causes the electronic device to perform the various steps of the methods described above.

The embodiments of the present disclosure are described with reference to the flowcharts and/or block diagrams of the method, the terminal device (system), and the computer program product according to the embodiments of the present disclosure. It is to be understood that computer program instructions can implement each process and/or block in the flowcharts and/or block diagrams and a combination of processes and/or blocks in the flowcharts and/or block diagrams. These computer program instructions may be provided for a general-purpose computer, a dedicated computer, an embedded processor, or a processor of any other programmable data processing terminal device to generate a machine, so that the instructions executed by a computer or a processor of any other programmable data processing terminal device generate an apparatus for implementing functions specified in one or more processes in the flowcharts and/or in one or more blocks in the block diagrams.

These computer program instructions may also be stored in a computer-readable memory that can guide a computer or another programmable data processing terminal device to work in a specific manner, so that the instructions stored in the computer-readable memory generate a product including an instruction apparatus, where the instruction apparatus implements functions specified in one or more processes in the flowcharts and/or in one or more blocks in the block diagrams.

These computer program instructions may also be loaded onto a computer or another programmable data processing terminal device, so that a series of operations and steps are performed on the computer or another programmable terminal device to generate computer-implemented processing. Therefore, the instructions executed on the computer or the another programmable terminal device provide steps for implementing functions specified in one or more processes in the flowcharts and/or in one or more blocks in the block diagrams.

At last, it should be noted that, in this specification, relational terms such as first and second are used only to distinguish one entity or operation from another, and do not necessarily require or imply any actual relationship or sequence between these entities or operations. Moreover, the terms “include”, “comprise”, and any variants thereof are intended to cover a non-exclusive inclusion. Therefore, a process, method, object, or terminal device that includes a series of elements not only includes such elements, but also includes other elements not specified expressly, or may include inherent elements of the process, method, object, or terminal device. Unless otherwise specified, an element limited by “include a/an . . . ” does not exclude other same elements existing in the process, method, object, or terminal device that includes the element.

1. A method for determining a summary of user-generated content, comprising:
determining a plurality of sequentially arranged sentences comprised in user-generated content;
determining a quality score of each sentence; and
determining a sentence group having the highest quality score according to a constraint condition of a maximum summary character length and the quality score of each sentence as a summary of the user-generated content, wherein sentences comprised in the sentence group are consecutive.

2. The method according to claim 1, wherein the determining a quality score of each sentence includes:
determining the quality score of the sentence according to information about a preset dimension of the sentence, wherein
the preset dimension comprises one or more of the following dimensions: text, entity, and opinion.

3. The method according to claim 2, wherein the determining the quality score of the sentence according to information about a preset dimension of the sentence comprises:
performing weighted summation on an entity dimension score and an opinion dimension score of the sentence, to obtain an initial quality score;
adjusting the initial quality score according to a text dimension score of the sentence; and
determining the adjusted initial quality score as the quality score of the sentence.

4. The method according to claim 1, wherein the determining a sentence group having the highest quality score as a summary of the user-generated content according to a constraint condition of a maximum summary character length and the quality score of each sentence comprises:
determining, by using a sliding window technology, one or more sentence groups satisfying the constraint condition of the maximum summary character length;
determining, for each sentence group, a weighted sum of quality scores of sentences comprised in the sentence group as a quality score of the sentence group; and
determining the sentence group having the highest quality score as the summary of the user-generated content.

5. The method according to claim 4, wherein weights of the quality scores of the sentences comprised in the sentence group are determined by using any one or more of the following factors:
for each sentence comprised in the sentence group, whether the sentence comprises an entity and an opinion;
a character length of the sentence group; and
whether the sentence group comprises the first sentence or the last sentence of the user-generated content.

6. A method for recommending user-generated content, comprising:
determining target businesses of a user;
determining candidate user-generated content according to evaluation scores of user-generated content of the target businesses;
determining target user-generated content matching the user in the candidate user-generated content;
determining a summary of the target user-generated content by using the method for determining a summary of user-generated content according to claim 1; and
recommending the summary of the target user-generated content to the user.

7. The method according to claim 6, further comprising:
determining the evaluation scores of the user-generated content according to information about the user-generated content in three dimensions: text, entity, and opinion.

8. The method according to claim 6, wherein the determining target businesses of a user comprises:
determining a business on which the user has generated a preset behavior as a first target business;
determining a second target business similar to the first target business based on a similarity between business vectors; and
using the first target business and the second target business as the target businesses of the user.

9. The method according to claim 8, further comprising:
training a business vector model by using a business sequence clicked by the user as an input of a word vector model; and
determining a business vector of the first target business by using the business vector model.

10. The method according to claim 6, wherein the determining target user-generated content matching the user in the candidate user-generated content comprises:
determining a matching degree between each piece of candidate user-generated content and the user respectively according to a sorting feature of each piece of candidate user-generated content and a user feature of the user; and
determining candidate user-generated content having a matching degree satisfying a preset condition as the target user-generated content matching the user, wherein
the sorting feature comprises any one or more of a like count, a comment count, a share count, a text quality score, an image quality score, an entity word, a level of a publisher of user-generated content, and a relationship between a publisher and the user;
the user feature comprises any one or more of a historical user behavior feature, a commercial area preference feature, a category preference feature, and a similar user feature; and
the historical user behavior feature comprises a feature of any one or more of a searching behavior, a browsing behavior, a purchasing behavior, and an behavior of entering a store.

11. An electronic device, comprising a memory, a processor, and a computer program that is stored in the memory and that is executable on the processor, the processor, when executing the computer program, performs the following operations, comprising:
determining a plurality of sequentially arranged sentences comprised in user-generated content;
determining a quality score of each sentence; and
determining a sentence group having the highest quality score according to a constraint condition of a maximum summary character length and the quality score of each sentence as a summary of the user-generated content, wherein sentences comprised in the sentence group are consecutive.

12. The electronic device according to claim 11, wherein the determining a quality score of each sentence includes:
determining the quality score of the sentence according to information about a preset dimension of the sentence, wherein
the preset dimension comprises one or more of the following dimensions: text, entity, and opinion.

13. The electronic device according to claim 12, wherein the determining the quality score of the sentence according to information about a preset dimension of the sentence comprises:
performing weighted summation on an entity dimension score and an opinion dimension score of the sentence, to obtain an initial quality score;
adjusting the initial quality score according to a text dimension score of the sentence; and determining the adjusted initial quality score as the quality score of the sentence.

14. The electronic device according to claim 11, wherein the determining a sentence group having the highest quality score as a summary of the user-generated content according to a constraint condition of a maximum summary character length and the quality score of each sentence comprises:
determining, by using a sliding window technology, one or more sentence groups satisfying the constraint condition of the maximum summary character length;
determining, for each sentence group, a weighted sum of quality scores of sentences comprised in the sentence group as a quality score of the sentence group; and
determining the sentence group having the highest quality score as the summary of the user-generated content.

15. The electronic device according to claim 14, wherein weights of the quality scores of the sentences comprised in the sentence group are determined by using any one or more of the following factors:
for each sentence comprised in the sentence group, whether the sentence comprises an entity and an opinion;
a character length of the sentence group; and
whether the sentence group comprises the first sentence or the last sentence of the user-generated content.

16. The electronic device according to claim 11, further comprising:
determining target businesses of a user;
determining candidate user-generated content according to evaluation scores of user-generated content of the target businesses;
determining target user-generated content matching the user in the candidate user-generated content;
determining a summary of the target user-generated content by using the method for determining a summary of user-generated content according to claim 1; and
recommending the summary of the target user-generated content to the user.

17. The electronic device according to claim 16, further comprising:
determining the evaluation scores of the user-generated content according to information about the user-generated content in three dimensions: text, entity, and opinion.

18. The electronic device according to claim 16, wherein the determining target businesses of a user comprises:
determining a business on which the user has generated a preset behavior as a first target business;
determining a second target business similar to the first target business based on a similarity between business vectors; and
using the first target business and the second target business as the target businesses of the user.

19. The electronic device according to claim 18, further comprising:
training a business vector model by using a business sequence clicked by the user as an input of a word vector model; and
determining a business vector of the first target business by using the business vector model.

20. A nonvolatile computer-readable storage medium, storing a computer program, the program, when executed by a processor, implementing the method for determining a summary of user-generated content according to claim 1.
